(19) United States
(12) Patent Application Publication
(10) Pub. No.: US 2020/0201970 A1
(43) Pub. Date: Jun. 25, 2020

(54) BIOMETRIC USER RECOGNITION

(71) Applicant: Cirrus Logic International Semiconductor Ltd., Edinburgh (GB)

(72) Inventor: John Paul LESSO, Edinburgh (GB)

(73) Assignee: Cirrus Logic International Semiconductor Ltd., Edinburgh (GB)

(21) Appl. No.: 16/716,004

(22) Filed: Dec. 16, 2019

Related U.S. Application Data
(60) Provisional application No. 62/782,504, filed on Dec. 20, 2018.

(51) Int. Cl. G06F 21/32; G10L 17/06; G10L 17/04; G10L 17/02

(52) U.S. Cl. CPC G06F 21/32; G10L 17/02; G10L 17/04; G10L 17/06

(57) ABSTRACT

A method of biometric user recognition comprises, in an enrolment stage, receiving first biometric data relating to a biometric identifier of the user; generating a plurality of biometric prints for the biometric identifier, based on the received first biometric data, and enrolling the user based on the plurality of biometric prints. Then, during a verification stage, the method comprises receiving second biometric data relating to the biometric identifier of the user; performing a comparison of the received second biometric data with the plurality of biometric prints; and performing user recognition based on the comparison.

### TECHNICAL FIELD

Embodiments described herein relate to methods and devices for biometric user recognition.

### BACKGROUND

Many systems use biometrics for the purpose of user recognition. As one example, speaker recognition is used to control access to systems such as smart phone applications and the like. Biometric systems typically operate with an initial enrolment stage, in which the enrolling user provides a biometric sample. For example, in the case of a speaker recognition system, the enrolling user provides one or more speech sample. The biometric sample is used to produce a biometric print. For example, in the case of a speaker recognition system, the biometric print is a biometric voice print, which acts as a model of the user's speech. In a subsequent verification stage, when a biometric sample is provided to the system, this newly received biometric sample can be compared with the biometric print of the enrolled user. It can then be determined whether the newly received biometric sample is sufficiently close to the biometric print to enable a decision that the newly received biometric sample was received from the enrolled user.

One issue that can arise with such systems is that some biometric identifiers, for example a user's voice, are not entirely consistent, that is, they have some natural variation from one sample to another. If the biometric sample that is received during the enrolment stage, and is used to form the biometric print, is somewhat atypical, this may mean that, in the subsequent verification stage, when a newly received biometric sample is compared with the biometric print of the enrolled user, this may produce misleading results.

### SUMMARY

According to an aspect of the present invention, there is provided a method of biometric user recognition, the method comprising:
in an enrolment stage:
receiving first biometric data relating to a biometric identifier of the user;
generating a plurality of biometric prints for the biometric identifier, based on the received first biometric data; and
enrolling the user based on the plurality of biometric prints, and, in a verification stage:
receiving second biometric data relating to the biometric identifier of the user;
performing a comparison of the received second biometric data with the plurality of biometric prints; and
performing user recognition based on said comparison.

According to another aspect, there is provided a system configured for performing the method. According to another aspect of the present invention, there is provided a device comprising such a system. The device may comprise a mobile telephone, an audio player, a video player, a mobile computing platform, a games device, a remote controller device, a toy, a machine, or a home automation controller or a domestic appliance.

According to another aspect of the present invention, there is provided a computer program product, comprising a computer-readable tangible medium, and instructions for performing a method according to the first aspect.

According to another aspect of the present invention, there is provided a non-transitory computer readable storage medium having computer-executable instructions stored thereon that, when executed by processor circuitry, cause the processor circuitry to perform a method according to the first aspect.

### BRIEF DESCRIPTION OF DRAWINGS

For a better understanding of the present invention, and to show how it may be put into effect, reference will now be made to the accompanying drawings, in which:—

FIG. 1 illustrates a smartphone;

FIG. 2 is a schematic diagram, illustrating the form of the smartphone;

FIG. 3 is a flow chart illustrating a method of enrolment of a user into a biometric identification system;

FIG. 4 illustrates a stage in the method of FIG. 3;

FIG. 5 illustrates a stage in the method of FIG. 3;

FIG. 6 illustrates a stage in the method of FIG. 3;

FIG. 7 illustrates a stage in the method of FIG. 3;

FIG. 8 illustrates a stage in the method of FIG. 3;

FIG. 9 illustrates a stage in the method of FIG. 3;

FIG. 10 is a flow chart illustrating a method of verification of a user in a biometric identification system; and

FIG. 11 illustrates a stage in the method of FIG. 10.

### DETAILED DESCRIPTION OF EMBODIMENTS

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

The methods described herein can be implemented in a wide range of devices and systems, for example a mobile telephone, an audio player, a video player, a mobile computing platform, a games device, a remote controller device, a toy, a machine, or a home automation controller or a domestic appliance. However, for ease of explanation of one embodiment, an illustrative example will be described, in which the implementation occurs in a smartphone.

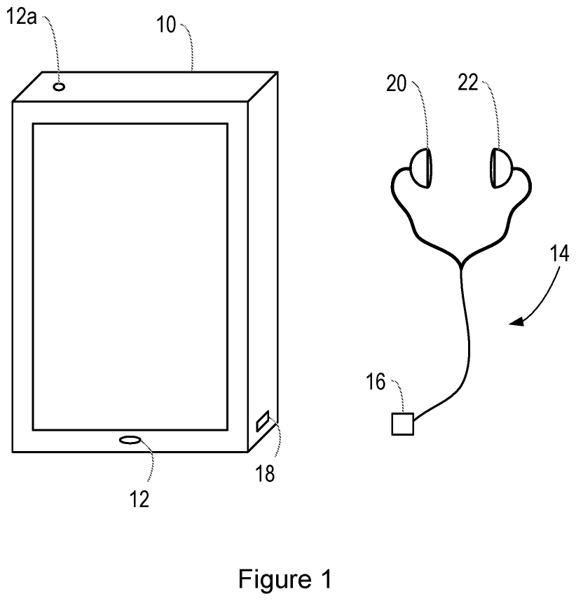

FIG. 1 illustrates a smartphone 10, having microphones 12, 12a for detecting ambient sounds. In addition, FIG. 1 shows a headset 14, which can be connected to the smartphone 10 by means of a plug 16 and a socket 18 in the smartphone 10. The smartphone 10 also includes two earpieces 20, 22, which each include a respective loudspeaker for playing sounds to be heard by the user. In addition, each earpiece 20, 22 may include a microphone, for detecting sounds in the region of the user's ears while the earpieces are in use.

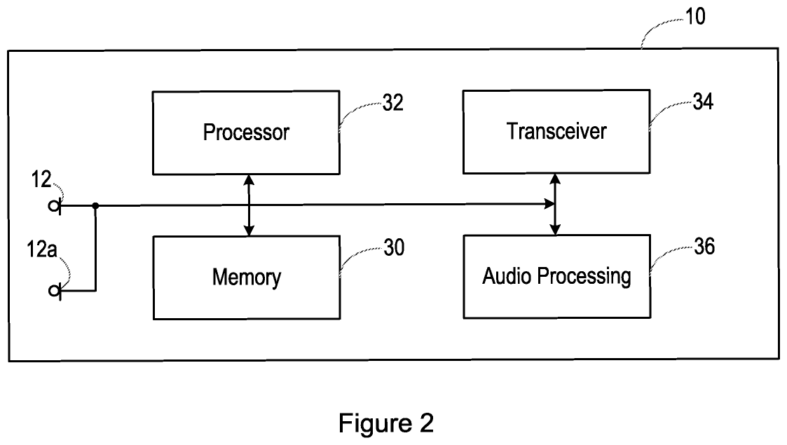

FIG. 2 is a schematic diagram, illustrating the form of the smartphone 10.

Specifically, FIG. 2 shows various interconnected components of the smartphone 10. It will be appreciated that the smartphone 10 will in practice contain many other components, but the following description is sufficient for an understanding of the present invention.

Thus, FIG. 2 shows the microphones 12, 12a mentioned above. In certain embodiments, the smartphone 10 is provided with more than two microphones.

FIG. 2 also shows a memory 30, which may in practice be provided as a single component or as multiple components. The memory 30 is provided for storing data and program instructions.

FIG. 2 also shows a processor 32, which again may in practice be provided as a single component or as multiple components. For example, one component of the processor 32 may be an applications processor of the smartphone 10.

FIG. 2 also shows a transceiver 34, which is provided for allowing the smartphone 10 to communicate with external networks. For example, the transceiver 34 may include circuitry for establishing an internet connection either over a WiFi local area network or over a cellular network.

FIG. 2 also shows audio processing circuitry 36, for performing operations on the audio signals detected by the microphones 12, 12a as required. For example, the audio processing circuitry 36 may filter the audio signals or perform other signal processing operations.

In some embodiments, the smartphone 10 is provided with voice biometric functionality, and with control functionality. Thus, the smartphone 10 is able to perform various functions in response to spoken commands from an enrolled user. The biometric functionality is able to distinguish between spoken commands from the enrolled user, and the same commands when spoken by a different person. Thus, certain embodiments of the invention relate to operation of a smartphone or another portable electronic device with some sort of voice operability, for example a tablet or laptop computer, a games console, a home control system, a home entertainment system, an in-vehicle entertainment system, a domestic appliance, or the like, in which the voice biometric functionality is performed in the device that is intended to carry out the spoken command. Certain other embodiments relate to systems in which the voice biometric functionality is performed on a smartphone or other device, which then transmits the commands to a separate device if the voice biometric functionality is able to confirm that the speaker was the enrolled user.

In some embodiments, while voice biometric functionality is performed on the smartphone 10 or other device that is located close to the user, the spoken commands are transmitted using the transceiver 34 to a remote speech recognition system, which determines the meaning of the spoken commands. For example, the speech recognition system may be located on one or more remote server in a cloud computing environment. Signals based on the meaning of the spoken commands are then returned to the smartphone 10 or other local device.

In other embodiments, the speech recognition is also performed on the smartphone 10.

In some embodiments, the smartphone 10 is provided with ear biometric functionality. That is, when certain actions or operations of the smartphone 10 are initiated by a user, steps are taken to determine whether the user is an enrolled user. Specifically, the ear biometric system determines whether the person wearing the headset 14 is an enrolled user. More specifically, specific test acoustic signals (for example in the ultrasound region) are played through the loudspeaker in one or more of the earpieces 20, 22. Then, the sounds detected by the microphone in the one or more of the earpieces 20, 22 are analysed. The sounds detected by the microphone in response to the test acoustic signal are influenced by the properties of the wearer's ear, and specifically the wearer's ear canal. The influence is therefore characteristic of the wearer. The influence can be measured, and can then be compared with a model of the influence that has previously been obtained during enrolment. If the similarity is sufficiently high, then it can be determined that the person wearing the headset 14 is the enrolled user, and hence it can be determined whether to permit the actions or operations initiated by the user.

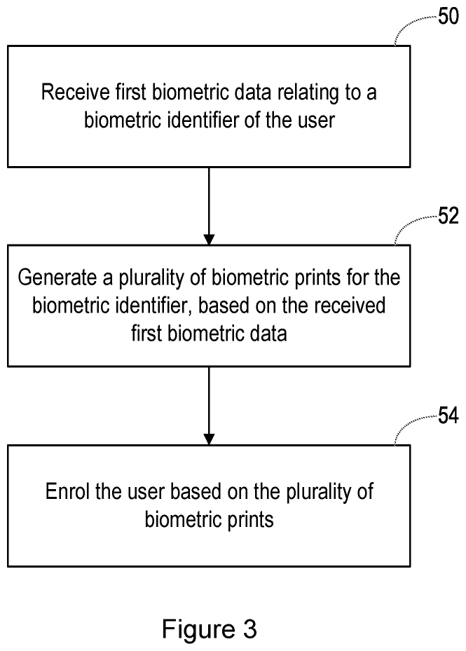

FIG. 3 is a flow chart, illustrating a method of enrolling a user in a biometric system. The method begins at step 50, when the user indicates that they wish to enrol in the biometric system. At step 50, first biometric data are received, relating to a biometric identifier of the user. At step 52, a plurality of biometric prints are generated for the biometric identifier, based on the received first biometric data. At step 54, the user may be enrolled, based on the plurality of biometric prints.

For example, when the biometric system is a voice biometric system, the step of receiving the first biometric data may comprise prompting the user to speak, and recording the speech generated by the user in response, using one or more of the microphones 12, 12a.

The embodiments described in further detail below assume that the biometric system is a voice biometric system, and the details of the system generally relate to a voice biometric system. However, it will be appreciated that the biometric system may use any suitable biometric, such as a fingerprint, a palm print, facial features, or iris features, amongst others.

As one specific example, when the biometric system is an ear biometric system, the step of receiving the first biometric data may comprise checking that the user is wearing the headset, and then playing the test acoustic signals (for example in the ultrasound region) through the loudspeaker in one or more of the earpieces 20, 22, and recording the resulting acoustic signal (the ear response signal) using the microphone in the one or more of the earpieces 20, 22.

As mentioned above, at step 52, a plurality of biometric prints are generated for the biometric identifier, based on the received first biometric data.

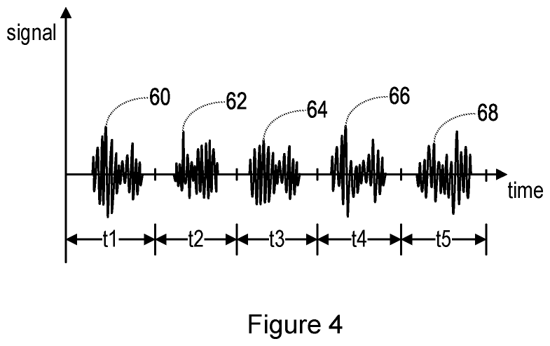

FIG. 4 illustrates a part of this step, in one embodiment. Specifically, FIG. 4 illustrates a situation where, in a voice biometric system, a user is prompted to speak a trigger word or phrase multiple times. FIG. 4 then illustrates the signal detected by the microphone 12 in response to the user's speech. Thus, there are bursts of sound during the time periods t1, t2, t3, t4, and t5, and the microphone generates signals 60, 62, 64, 66, and 68, respectively during these time periods. Thus, the microphone signal generated during these periods acts as voice biometric data. (Similarly, if the biometric system is an ear biometric system, the step of receiving the first biometric data may comprise playing a test acoustic signal multiple times, and detecting a separate ear response signal each time the test acoustic signal is played.)

Conventionally, these separate utterances of the trigger word or phrase are concatenated, and a voice print is formed from the concatenated signal. In the method described herein, multiple voice prints are formed from the voice biometric data received during the time periods t1, t2, t3, t4, t5.

For example, a first voice print may be formed from the signal 60, a second voice print may be formed from the signal 62, a third voice print may be formed from the signal 64, a fourth voice print may be formed from the signal 66, and a fifth voice print may be formed from the signal 68.

Moreover, further voice prints may be formed from pairs of the signals, and/or from groups of three of the signals, and/or from groups of four of the signals. In particular, a further voice print may be formed from all five of the signals. A convenient number of voice prints can then be obtained from different combinations of signals. For example, a resampling methodology such as a bootstrapping technique can be used to select groups of the signals that are used to form respective voice prints. More generally, one, or more, or all of the voice prints, may be formed from a combinatorial selection of sections.

In a situation where there are three signals, representing three different utterances of a trigger word or phrase, a total of seven voice prints may be obtained, from the three signals separately, the three possible pairs of signals, and the three signals taken together.

Although, as described above, a user may be prompted to repeat the same trigger word or phrase multiple times, it is also possible to use a single utterance of the user, and divide it into multiple sections, and to generate the multiple voice prints using the multiple sections in the same way as described above for the separate utterances.

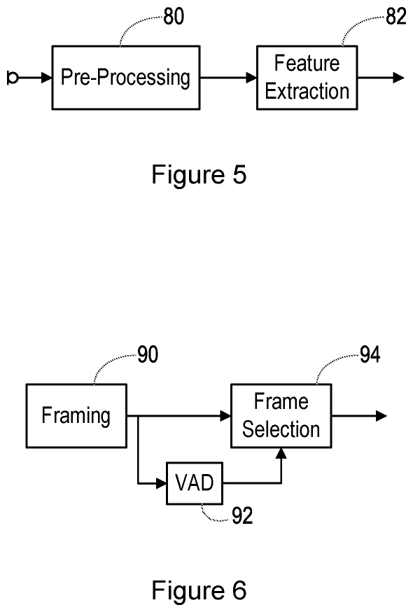

FIG. 5 illustrates a further part of step 52, in which the plurality of biometric prints are generated for the biometric identifier, based on the received first biometric data.

Specifically, FIG. 5 shows that the received signal is passed to a pre-processing block 80, which performs pre-processing operations on the received signal. The pre-processed signal is then passed to a feature extraction block 82, which extracts specific predetermined features from the pre-processed signal. The step of feature extraction may for example comprise extracting Mel Frequency Cepstral Coefficients (MFCCs) from the pre-processed signal. The set of extracted MFCCs then act as a model of the user's speech, or a voice print.

The step of performing the pre-processing operations on the received signal comprises receiving the signal, and performing pre-processing operations that put the received signal into a form in which the relevant features can be extracted.

FIG. 6 illustrates one possible form of the pre-processing block 80. In this example, the received signal is passed to a framing block 90, which divides the received signal into frames of a predetermined duration. In one example, each frame consists of 320 samples of data (and has a duration of 20 ms). Further, each frame overlaps the preceding frame by 50%. That is, if the first frame consists of samples numbered 1-320, the second frame consists of samples numbered 161-480, the third frame consists of samples numbered 321-480, etc.

The frames generated by the framing block 90 are passed to a voice activity detector (VAD) 92, which attempts to detect the presence of speech in each frame of the received signal.

The output of the framing block 90 is also passed to a frame selection block 94, and the VAD 92 sends a control signal to the frame selection block 94, so that only those frames that contain speech are considered further. If necessary, the data passed to the frame selection block 94 may be passed through a buffer, so that the frame that contains the start of the speech will be recognised as containing speech.

As described with reference to FIG. 4, the received signal may be divided into multiple sections, and these sections may be kept separate or combined as desired to produce respective signal segments. These signal segments are applied to the pre-processing block 80 and feature extraction block 82, such that a respective voice print is formed from each signal segment.

Thus, in some embodiments, a received speech signal is divided into sections, and multiple voice prints are formed from these sections.

In other embodiments, multiple voice prints are formed from a received speech signal without dividing it into sections.

In one example of this, multiple voice prints are formed from differently framed versions of a received speech signal. Similarly, multiple ear biometric prints can be formed from differently framed versions of an ear response signal that is generated in response to playing a test acoustic signal or tone through the loudspeaker in the vicinity of a wearer's ear.

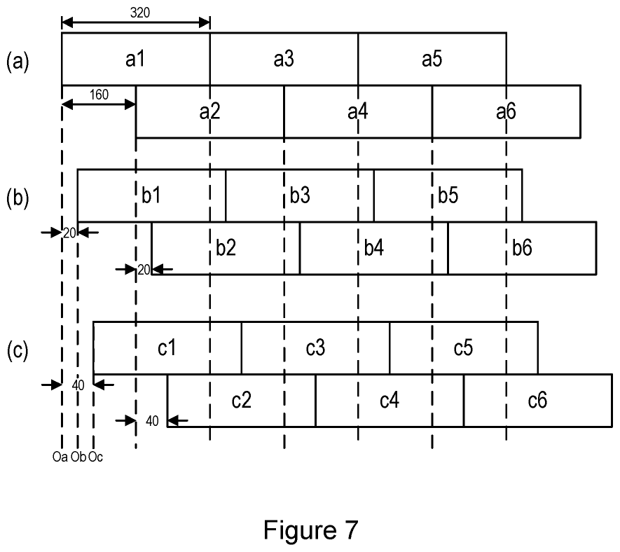

FIG. 7 illustrates the formation of a plurality of differently framed versions of the received audio signal, each of the framed versions having a respective frame start position. In this example, the entire received audio signal may be passed to the framing block 90 that is shown in FIG. 6.

In this illustrated example, as described above, each frame consists of 320 samples of data (with a duration of 20 ms). Further, each frame overlaps the preceding frame by 50%.

FIG. 7(a) shows a first one of the framed versions of the received audio signal. Thus, as shown in FIG. 7(a), a first frame a1 has a length of 320 samples, a second frame a2 starts 160 samples after the first frame, a third frame a3 starts 160 samples after the second (i.e. at the end of the first frame), and so on for the fourth frame a4, the fifth frame a5, and the sixth frame a6, etc.

The start of the first frame a1 in this first framed version is at the frame start position Oa.

As shown in FIG. 7(b), again in this illustrated example, each frame consists of 320 samples of data (with a duration of 20 ms). Further, each frame overlaps the preceding frame by 50%.

FIG. 7(b) shows another of the framed versions of the received audio signal. Thus, as shown in FIG. 7(b), a first frame b1 has a length of 320 samples, a second frame b2 starts 160 samples after the first frame, a third frame b3 starts 160 samples after the second (i.e. at the end of the first frame), and so on for the fourth frame b4, the fifth frame b5, and the sixth frame b6, etc.

The start of the first frame b1 in this second framed version is at the frame start position Ob, and this is offset from the frame start position Oa of the first framed version by 20 sample periods.

As shown in FIG. 7(c), again in this illustrated example, each frame consists of 320 samples of data (with a duration of 20 ms). Further, each frame overlaps the preceding frame by 50%.

FIG. 7(c) shows another of the framed versions of the received audio signal. Thus, as shown in FIG. 7(c), a first frame c1 has a length of 320 samples, a second frame c2 starts 160 samples after the first frame, a third frame c3 starts 160 samples after the second (i.e. at the end of the first frame), and so on for the fourth frame c4, the fifth frame c5, and the sixth frame c6, etc.

The start of the first frame c1 in this third framed version is at the frame start position Oc, and this is offset from the frame start position Ob of the second framed version by a further 20 sample periods, i.e. it is offset from the frame start position Oa of the first framed version by 40 sample periods.

In this example, three framed versions of the received signal are illustrated. It will be appreciated that, with a separation of 160 sample periods between the start positions of successive frames, and an offset of 20 sample periods between different framed versions, eight framed versions can be formed in this way.

In other examples, the offset between different framed versions can be any desired value. For example, with an offset of two sample periods between different framed versions, 80 framed versions can be formed; with an offset of four sample periods between different framed versions, 40 framed versions can be formed; with an offset of five sample periods between different framed versions, 32 framed versions can be formed; with an offset of eight sample periods between different framed versions, 20 framed versions can be formed; or with an offset of 10 sample periods between different framed versions, 16 framed versions can be formed.

In other examples, the offset between each adjacent pair of different framed versions need not be exactly the same. For example, with some of the offsets being 26 sample periods and other offsets being 27 sample periods, six framed versions can be formed.

The different framed versions, generated by the framing block 90, are then passed to the voice activity detector (VAD) 92 and the frame selection block 94, as described with reference to FIG. 6. The VAD 92 attempts to detect the presence of speech in each frame of the current version of the received signal, and sends a control signal to the frame selection block 94, so that only those frames that contain speech are considered further. If necessary, the data passed to the frame selection block 94 may be passed through a buffer, so that the frame that contains the start of the speech will be recognised as containing speech. Further, since there is an overlap between the frames in each version, and also a further overlap between the frames in one framed version and in each other framed version, the data making up the frames may be buffered as appropriate, so that the calculations involved in the feature extraction can be performed on each frame of the relevant framed versions, with the minimum of delay.

Thus, for each of the differently framed versions, a sequence of frames containing speech is generated. These sequences are passed, separately, to the feature extraction block 82 shown in FIG. 5, and a separate voice print is generated for each of the differently framed versions.

Thus, in the embodiment described above, multiple voice prints are formed from differently framed versions of a received speech signal.

In other embodiments, multiple voice prints are formed from a received speech signal in a way that takes account of different degrees of vocal effort that may be made by a user when performing speaker verification. That is, it is known that the vocal effort used by a speaker will distort spectral features of the speaker's voice. This is referred to as the Lombard effect.

In this embodiment, it may be assumed that the user will perform the enrolment process under relatively favourable conditions, for example in the presence of low ambient noise, and with the device positioned relatively close to the user's mouth. The instructions provided to the user at the start of the enrolment process may suggest that the process be carried out under such conditions. Moreover, measurement of metrics such as the signal-to-noise ratio may be used to test that the enrolment was performed under suitable conditions. In such conditions, the vocal effort required will be relatively low.

However, it is recognised that, in use after enrolment, when it is desired to verify that a speaker is indeed the enrolled user, the level of vocal effort employed by the user may vary. For example, the user may be in the presence of higher ambient noise, or may be speaking into a device that is located at some distance from their mouth, for example.

These embodiments therefore attempt to generate multiple voice prints from a received speech signal, where the different voice prints may each be appropriate for a certain level of vocal effort on the part of the speaker.

As before, a signal is detected by the microphone 12, for example when the user is prompted to speak a trigger word or phrase, either once or multiple times, typically after the user has indicated a wish to enrol with the speaker recognition system. Alternatively, the speech signal may represent words or phrases chosen by the user. As a further alternative, the enrolment process may be started on the basis of random speech of the user.

As described previously, the received signal is passed to a pre-processing block 80, as shown in FIG. 5.

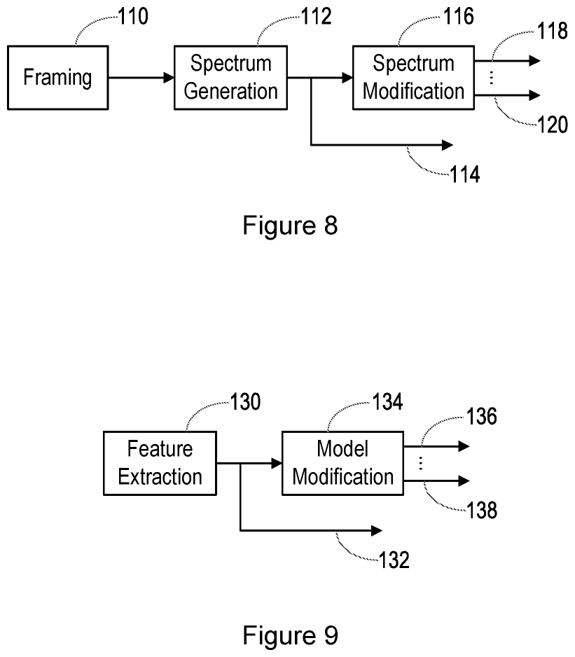

FIG. 8 is a block diagram, showing the form of the pre-processing block 80, in some embodiments. Specifically, a received signal is passed to a framing block 110, which divides the received signal into frames.

As described previously, the received signal may be divided into overlapping frames. As one example, the received signal may be divided into frames of length 20 ms, with each frame overlapping the preceding frame by 10 ms. As another example, the received signal may be divided into frames of length 30 ms, with each frame overlapping the preceding frame by 15 ms.

A frame is passed to a spectrum estimation block 112. The spectrum generation block 112 extracts the short term spectrum of one frame of the user's speech. For example, the spectrum generation block 112 may perform a linear prediction (LP) method. More specifically, the short term spectrum can be found using an L1-regularised LP model to perform an all-pole analysis.

Based on the short term spectrum, it is possible to determine whether the user's speech during that frame is voiced or unvoiced. There are several methods that can be used to identify voiced and unvoiced speech, for example: using a deep neural network (DNN), trained against a golden reference, for example using Praat software; performing an autocorrelation with unit delay on the speech signal (because voiced speech has a higher autocorrelation for non-zero lags); performing a linear predictive coding (LPC) analysis (because the initial reflection coefficient is a good indicator of voiced speech); looking at the zero-crossing rate of the speech signal (because unvoiced speech has a higher zero-crossing rate); looking at the short term energy of the signal (which tends to be higher for voiced speech); tracking the first formant frequency F0 (because unvoiced speech does not contain the first format frequency); examining the error in a linear predictive coding (LPC) analysis (because the LPC prediction error is lower for voiced speech); using automatic speech recognition to identify the words being spoken and hence the division of the speech into voiced and unvoiced speech; or fusing any or all of the above.

Voiced speech is more characteristic of a particular speaker, and so, in some embodiments, frames that contain little or no voiced speech are discarded, and only frames that contain significant amounts of voiced speech are considered further.

The extracted short term spectrum for each frame is passed to an output 114.

In addition, the extracted short term spectrum for each frame is passed to a spectrum modification block 116, which generates at least one modified spectrum, by applying effects related to a respective vocal effort.

That is, it is recognised that the vocal effort used by a speaker will distort spectral features of the speaker's voice. This is referred to as the Lombard effect.

As mentioned above, it may be assumed that the user will perform the enrolment process under relatively favourable conditions, for example in the presence of low ambient noise, and with the device positioned relatively close to the user's mouth. The instructions provided to the user at the start of the enrolment process may suggest that the process be carried out under such conditions. Moreover, measurement of metrics such as the signal-to-noise ratio may be used to test that the enrolment was performed under suitable conditions. In such conditions, the vocal effort required will be relatively low. However, it is recognised that, in use after enrolment, when it is desired to verify that a speaker is indeed the enrolled user, the level of vocal effort employed by the user may vary. For example, the user may be in the presence of higher ambient noise, or may be speaking into a device that is located at some distance from their mouth, for example.

Thus, one or more modified spectrum is generated by the spectrum modification block 116. The or each modified spectrum corresponds to a particular level of vocal effort, and the modifications correspond to the distortions that are produced by the Lombard effect.

For example, in one embodiment, the spectrum obtained by the spectrum generation block 112 is characterised by a frequency and a bandwidth of one or more formant components of the user's speech. For example, the first four formants may be considered. In another embodiment, only the first formant is considered. Where the spectrum generation block 112 performs an all-pole analysis, as mentioned above, the conjugate poles contributing to those formants may be considered.

Then, one or more respective modified formant components is generated. For example, the modified formant component or components may be generated by modifying at least one of the frequency and the bandwidth of the formant component or components. Where the spectrum generation block 112 performs an all-pole analysis, and the conjugate poles contributing to those formants are considered, as mentioned above, the modification may comprise modifying the pole amplitude and/or angle in order to achieve the intended frequency and/or bandwidth modification.

For example, with increasing vocal effort, the frequency of the first formant, F1, may increase, while the frequency of the second formant, F2, may slightly decrease. Similarly, with increasing vocal effort, the bandwidth of each formant may decrease. One attempt to quantify the changes in the frequency and the bandwidth of the first four formant components, for different levels of ambient noise, is provided in I. Kwak and H. G. Kang, “Robust formant features for speaker verification in the Lombard effect”, 2015 Asia-Pacific Signal and Information Processing Association Annual Summit and Conference (APSIPA), Hong Kong, 2015, pp. 114-118. The ambient noise causes the speaker to use a higher vocal effort, and this change in vocal effort produces effects on the spectrum of the speaker's speech.

A modified spectrum can then be obtained from each set of modified formant components.

Thus, as examples, one, two, three, four, five, up to ten, or more than ten modified spectra may be generated, each having modifications that correspond to the distortions that are produced by a particular level of vocal effort.

By way of example, in which only the first formant is considered, FIG. 3 of the document “Robust formant features for speaker verification in the Lombard effect”, mentioned above, indicates that the frequency of the first formant, F1, will on average increase by about 10% in the presence of babble noise at 65 dB SPL, by about 14% in the presence of babble noise at 70 dB SPL, by about 17% in the presence of babble noise at 75 dB SPL, by about 8% in the presence of pink noise at 65 dB SPL, by about 11% in the presence of pink noise at 70 dB SPL, and by about 15% in the presence of pink noise at 75 dB SPL. Meanwhile, FIG. 4 indicates that the bandwidth of the first formant, F1, will on average decrease by about 9% in the presence of babble noise at 65 dB SPL, by about 9% in the presence of babble noise at 70 dB SPL, by about 11% in the presence of babble noise at 75 dB SPL, by about 8% in the presence of pink noise at 65 dB SPL, by about 9% in the presence of pink noise at 70 dB SPL, and by about 10% in the presence of pink noise at 75 dB SPL.

Therefore, these variations can be used to form modified spectra from the spectrum obtained by the spectrum generation block 112. For example, if it is desired to form two modified spectra, then the effects of babble noise and pink noise, both at 70 dB SPL, can be used to form the modified spectra.

Thus, a modified spectrum representing the effects of babble noise at 70 dB SPL can be formed by taking the spectrum obtained in step 52, and by then increasing the frequency of the first formant, F1, by 14%, and decreasing the bandwidth of F1 by 9%. A modified spectrum representing the effects of pink noise at 70 dB SPL can be formed by taking the spectrum obtained in step 52, and by then increasing the frequency of the first formant, F1, by 11%, and decreasing the bandwidth of F1 by 9%.

FIGS. 3 and 4 of the document mentioned above also indicate the changes that occur in the frequency and bandwidth of other formants, and so these effects can also be taken into consideration when forming the modified spectra, in other examples.

As mentioned above, any desired number of modified spectra may be generated, each corresponding to a particular level of vocal effort, and the modified spectra are output as shown at 118, . . . , 120 in FIG. 8. Returning to FIG. 5, the extracted short term spectrum for the frame, and the or each modified spectrum, are then passed to the feature extraction block 82, which extracts features of the spectra.

In this case, the features that are extracted may be Mel Frequency Cepstral Coefficients (MFCCs), although any suitable features may be extracted, for example Perceptual Linear Prediction (PLP) features, Linear Predictive Coding (LPC) features, Linear Frequency Cepstral coefficients (LFCC), features extracted from Wavelets or Gammatone filterbanks, or Deep Neural Network (DNN)-based features may be extracted.

When every frame has been analysed, a model of the speech, or biometric voice print, is formed corresponding to each of the levels of vocal effort.

That is, one voice print may be formed, based on the extracted features of the spectra for the multiple frames of the enrolling speaker's speech. A respective further voice print may then be formed, based on the modified spectrum obtained from the multiple frames, for each of the effort levels used to generate the respective modified spectrum. Thus, in this case, if two modified spectra are generated for each frame, based on first and second levels of additional vocal effort, then one voice print may be formed, based on the extracted features of the unmodified spectra for the multiple frames of the enrolling speaker's speech, and two additional voice prints may be formed, with one additional voice print being based on the spectra for the multiple frames of the enrolling speaker's speech modified according to the first level of additional vocal effort, and the second additional voice print being based on the spectra for the multiple frames of the enrolling speaker's speech modified according to the second level of additional vocal effort.

Thus, the embodiment described above generate multiple voice prints from a received speech signal, where the different voice prints may each be appropriate for a certain level of vocal effort on the part of the speaker, and does this by extracting a property of the received speech signal, manipulating this property to reflect different levels of vocal effort, and generating the voice prints from the manipulated properties.

In another embodiment, one voice print is generated from the received speech signal, and further voice prints are derived by manipulating the first voice print, such that the further voice prints are each appropriate for a certain level of vocal effort on the part of the speaker.

More specifically, as shown in FIG. 5, and as described above, the received speech signal is passed to a pre-processing block 80, which performs pre-processing operations on the received signal, for example as described with reference to FIG. 6, in which frames containing speech are selected.

FIG. 9 is a block diagram showing the processing of the selected frames. Specifically, FIG. 9 shows the pre-processed signal being passed to a feature extraction block 130, which extracts specific predetermined features from the pre-processed signal. The step of feature extraction may for example comprise extracting Mel Frequency Cepstral Coefficients (MFCCs) from the pre-processed signal. The set of extracted MFCCs then act as a model of the user's speech, or a voice print, and the voice print is output as shown at 132.

The voice print is also passed to a model modification block 134, which applies transforms to the basic voice print to generate one or more different voice prints, output as shown at 136, . . . , 138, each of which reflects a respective level of vocal effort on the part of the speaker.

Thus, in both of the examples described with reference to FIGS. 8 and 9, models are generated that take account of possible distortions caused by additional vocal effort.

FIG. 3 therefore shows a method, in which multiple voice prints are generated, as part of a process of enrolling a user into a biometric user recognition scheme.

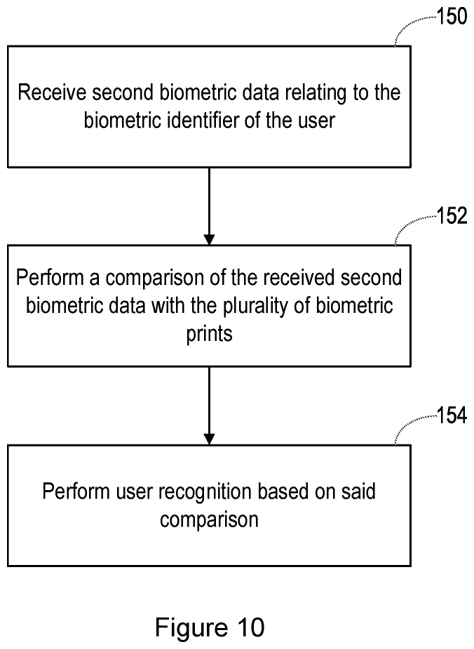

FIG. 10 is a flow chart, illustrating a method performed during a verification stage, once a user has been enrolled. The verification stage may for example be initiated when a user of a device performs an action or operation, whose execution depends on the identity of the user. For example, if a home automation system receives a spoken command to “play my favourite music”, the system needs to know which of the enrolled users was speaking. As another example, if a smartphone receives a command to transfer money by means of a banking program, the program may require biometric authentication that the person giving the command is authorised to do so.

At step 150, the method involves receiving second biometric data relating to the biometric identifier of the user. The second biometric data is of the same type as the first biometric data received during enrolment. That is, the second biometric data may be voice biometric data, for example in the form of signals representing the user's speech; ear biometric data, or the like.

At step 152, the method involves performing a comparison of the received second biometric data with the plurality of biometric prints that were generated during the enrolment stage. The process of comparison may be performed using any convenient method. For example, in the case of biometric voice prints, the comparison may be performed by detecting the user's speech, extracting features from the detected speech signal as described with reference to the enrolment, and forming a model of the user's speech. This model may then be compared separately with the multiple biometric voice prints.

Then, at step 154, the method involves performing user recognition based on the comparison of the received second biometric data with the plurality of biometric prints.

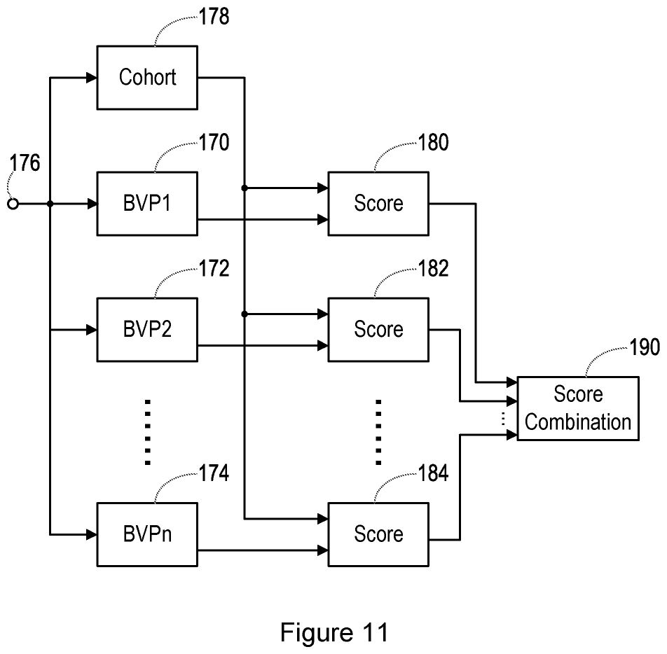

FIG. 11 is a block diagram, illustrating one possible way of performing the comparison of the received second biometric data with the plurality of biometric prints. The further description of FIG. 11 assumes that the system is a voice biometric system, and hence that the received second biometric data is speech data, and the plurality of biometric prints are voice prints. However, as described above, it will be appreciated that any other suitable biometric may be used.

Thus, a number of biometric voice prints (BVP), namely BVP1, BVP2, . . . , BVPn, indicated by reference numerals 170, 172, 174 are stored. A speech signal obtained during the verification stage is received at 176, and compared separately with each of the voice prints 170, 172, 174. Each comparison gives rise to a respective score S1, S2, . . . , Sn.

Voice prints 178 for a cohort of other speakers are also provided, and the received speech signal is also compared separately with each of the cohort voice prints, and each of these comparisons also gives rise to a score. The mean μ and standard deviation a of these scores can then be calculated.

The scores S1, S2, . . . , Sn are then passed to respective score normalisation blocks 180, 182, . . . , 184, which also each receive the mean μ and standard deviation a of the scores obtained from the comparison with the cohort voice prints. A respective normalised value S1*, S2*, . . . , Sn* is then derived from each of the scores S1, S2, . . . , Sn as:

Sk*=(Sk−μ)/σ

These normalised scores S1*, S2*, . . . , Sn* are then passed to a score combination block 190, which produces a final score.

In a further development, the normalisation process may use modified values of the mean μ and/or standard deviation a of the scores obtained from the comparison with the cohort voice prints. More specifically, in one embodiment, the normalisation process uses a modified value σ₂ of the standard deviation σ, where the modified value σ₂ is calculated using the standard deviation σ and a prior tuning factor σ₀, as:

σ₂²=γσ₀²+(1−γ)σ²

where γ may be a constant or a tuneable delay factor.

The example normalisation process described here uses the mean μ and standard deviation σ of the scores obtained from the comparison with the cohort voice prints, but it will be noted that other normalisation processes may be used, for example using another measure of dispersion, such as the median absolute deviation or the mean absolute deviation instead of the standard deviation in order to derive normalised values from the respective scores generated by the comparisons with the voice prints.

For example, the score combination block 190 may operate by calculating a mean of the normalised scores S1*, S2*, . . . , Sn*. The resulting mean value can be taken as a combined score, which can be compared with an appropriate threshold to determine whether the user who provided the second biometric data (i.e. the speech sample acting as voice biometric data in the illustrated example) can be assumed to be the enrolled user who provided the first biometric data.

As another example, the score combination block 190 may operate by calculating a trimmed mean of the normalised scores S1*, S2*, . . . , Sn*. That is, the scores are placed in ascending (or descending order), and the highest and lowest values are discarded, with the trimmed mean being calculated as the mean after the highest and lowest scores have been discarded. As above, the trimmed mean value can be taken as a combined score, which can be compared with an appropriate threshold to determine whether the user who provided the second biometric data (i.e. the speech sample acting as voice biometric data in the illustrated example) can be assumed to be the enrolled user who provided the first biometric data.

As another example, the score combination block 190 may operate by calculating a median of the normalised scores S1*, S2*, . . . , Sn*. The resulting median value can be taken as a combined score, which can be compared with an appropriate threshold to determine whether the user who provided the second biometric data (i.e. the speech sample acting as voice biometric data in the illustrated example) can be assumed to be the enrolled user who provided the first biometric data.

As a further example, each of the normalised scores S1*, S2*, . . . , Sn* can be compared with a suitable threshold value, which has been set such that a score above the threshold value indicates a certain probability that the user who provided the second biometric data was the enrolled user who provided the first biometric data. Then, a combined result can be obtained by examining the results of these comparisons. For example, if the normalised score exceeds the threshold value in a majority of the comparisons, this can be taken to indicates that the user who provided the second biometric data was the enrolled user who provided the first biometric data. Conversely, if the normalised score is lower than the threshold value in a majority of the comparisons, this can be taken to indicates that it is not safe to assume that the user who provided the second biometric data was the enrolled user who provided the first biometric data.

These methods of performing user recognition, based on the comparison of the received second biometric data with the plurality of biometric prints, have the advantage that the presence of an inappropriate biometric print does not have the effect that all subsequent attempts at user recognition become more difficult.

Further embodiments, in which first biometric data is used to generate a plurality of biometric prints for the enrolment of the user, and the verification stage then involves comparing received biometric data with the plurality of biometric prints for the purposes of user recognition, relate to biometric identifiers whose properties vary with time.

For example, it has been found that the properties of people's ears typically vary over the course of a day.

Therefore, in some embodiments, the enrolment stage involves receiving first biometric data relating to a biometric identifier of the user on a plurality of enrolment occasions at at least two different respective points in time. These points in time are noted. Where the biometric identifier varies with a daily cycle, the enrolment occasions may occur at different times of day. For other cycles, appropriate enrolment occasions may be selected.

In the example of an ear biometric system, the first biometric data may relate to the response of the user's ear to an audio test signal, for example a test tone, which may be in the ultrasound range. A first sample of the first biometric data may be obtained in the morning, and a second sample of the first biometric data may be obtained in the evening.

A plurality of biometric prints are then generated for the biometric identifier, based on the received first biometric data. For example, separate biometric prints may be generated for the different points in time at which the first biometric data is obtained.

In the example of the ear biometric system, as described above, a first biometric print may be generated from the first biometric data obtained in the morning, and hence may reflect the properties of the user's ear in the morning, while a second biometric print may be generated from the first biometric data obtained in the evening, and hence may reflect the properties of the user's ear in the evening.

The user is then enrolled on the basis of the plurality of biometric prints.

In the verification stage, second biometric data is generated, relating to the same biometric identifier of the user. A point in time at which the second biometric data is received is noted.

As before, in the example of an ear biometric system, the second biometric data may relate to the response of the user's ear to an audio test signal, at a time when it is required to perform user recognition, for example when the user wishes to instruct a host device to perform a specific action that requires authorisation.

The verification stage then involves performing a comparison of the received second biometric data with the plurality of biometric prints.

For example, the received second biometric data may be separately compared with the plurality of biometric prints to give a respective plurality of scores, and these scores may then be combined in an appropriate way.

The comparison of the received second biometric data with the plurality of biometric prints may be performed in a manner that depends on the point in time at which the second biometric data was received and the points in respective points in time at which the first biometric data corresponding to the biometric prints was received. For example, a weighted sum of comparison scores may be generated, with the weightings being chosen based on the respective points in time.

In the example of the ear biometric system, as described above, where a first biometric print reflects the properties of the user's ear in the morning, while a second biometric print reflects the properties of the user's ear in the evening, these comparisons may give rise to scores Sₘₒₘ and Sₑᵥₑ respectively.

Then, the combination may give a total score S as:

S=α·Sₘₒᵣₙ+(1−α)·Sₑᵥₑ

where α is a parameter that varies throughout the day, such that, earlier in the day, the total score gives more weight to the comparison with the first biometric print that reflects the properties of the user's ear in the morning, and, later in the day, the total score gives more weight to the comparison with the second biometric print that reflects the properties of the user's ear in the evening.

The user recognition decision, for example the decision as to whether to grant authorisation for the action requested by the user, can then be based on the total score. For example, authorisation may be granted if the total score exceeds a threshold, where the threshold value may depend on the nature of the requested action.

There is thus disclosed a system in which enrolment of users into a biometric user recognition system can be made more reliable.

The skilled person will recognise that some aspects of the above-described apparatus and methods, for example the discovery and configuration methods may be embodied as processor control code, for example on a non-volatile carrier medium such as a disk, CD- or DVD-ROM, programmed memory such as read only memory (Firmware), or on a data carrier such as an optical or electrical signal carrier. For many applications, embodiments will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A method of biometric user recognition, the method comprising:
in an enrolment stage:
receiving first biometric data relating to a biometric identifier of the user;
generating a plurality of biometric prints for the biometric identifier, based on the received first biometric data; and
enrolling the user based on the plurality of biometric prints,
and, in a verification stage:
receiving second biometric data relating to the biometric identifier of the user;
performing a comparison of the received second biometric data with the plurality of biometric prints; and
performing user recognition based on said comparison.

2. The method according to claim 1, wherein the biometric user recognition system is a voice biometric system.

3. The method according to claim 1, wherein the biometric user recognition system is an ear biometric system.

4. A method according to claim 2, wherein a received speech signal is divided into sections, and multiple voice prints are formed from these sections.

5. The method according to claim 4, wherein a respective voice print is formed from each of said sections.

6. The method according to claim 4, wherein at least one voice print is formed from a plurality of said sections.

7. The method according to claim 6, wherein at least one voice print is formed from a combinatorial selection of sections.

8. The method according to claim 2, wherein multiple voice prints are formed from a received speech signal without dividing it into sections.

9. The method according to claim 8, comprising:
generating differently framed versions of the received speech signal, and
generating a separate voice print for each of the differently framed versions.

10. The method according to claim 8, comprising:
generating multiple voice prints from a received speech signal, where the different voice prints may each be appropriate for a certain level of vocal effort on the part of the speaker.

11. The method according to claim 10, comprising:
extracting a property of the received speech signal,
generating a first voice print based on the property,
manipulating the property to reflect different levels of vocal effort, and
generating other voice prints from the manipulated properties.

12. The method according to claim 11, wherein the extracted property of the received speech signal is a spectrum of the received speech signal.

13. The method according to claim 10, comprising:
generating a first voice print from the received speech signal, and
applying one or more transforms to the first voice print to generate one or more different voice prints, each of which reflects a respective level of vocal effort on the part of the speaker.

14. The method according to claim 3, comprising:
playing a test signal in a vicinity of a user's ear;
receiving an ear response signal;
generating differently framed versions of the received ear response, and
generating a separate biometric print for each of the differently framed versions.

15. The method according to claim 3, wherein the step of receiving first biometric data comprises receiving a plurality of ear response signals at a plurality of times.

16. The method according to claim 15, comprising:
enrolling the user based on the plurality of biometric prints generated from the plurality of ear response signals received at the plurality of times; and
in the verification stage:
performing the comparison of the received second biometric data with the plurality of biometric prints based on a time of day at which the second biometric data was received.

17. The method according to claim 16, wherein the step of performing the comparison of the received second biometric data with the plurality of biometric prints comprises:
comparing the received second biometric data with a first biometric print obtained at a first time of day, to produce a first score;
comparing the received second biometric data with a second biometric print obtained at a second time of day, to produce a second score; and
forming a weighted sum of the first and second scores, with a weighting factor being determined based on the time of day at which the second biometric data was received.

18. The method according to claim 1, wherein the biometric identifier has properties that vary with time, the method comprising:
in the enrolment stage:
receiving the first biometric data on a plurality of enrolment occasions at respective points in time; and,
in the verification stage:
noting a point in time at which the second biometric data is received;
performing the comparison of the received second biometric data with the plurality of biometric prints in a manner that depends on the point in time at which the second biometric data is received and the points in respective points in time at which the first biometric data corresponding to said biometric prints was received.

19. The method according to claim 1, wherein
the step of performing a comparison of the received second biometric data with the plurality of biometric prints comprises:
comparing the received second biometric data with the plurality of biometric prints to obtain respective score values,
comparing the received second biometric data with a cohort of biometric prints to obtain cohort score values, and
normalising the respective score values based on the cohort score values.

20. The method according to claim 19, wherein the step of normalising the respective score values based on the cohort score values comprises adjusting the score values based on a mean and a measure of dispersion of the cohort score values.

21. The method according to claim 20, wherein the step of normalising the respective score values based on the cohort score values comprises adjusting the score values based on a modified mean and/or a modified measure of dispersion of the cohort score values.

22. The method according to claim 19, wherein the step of performing user recognition based on said comparison comprises calculating a mean of the normalised scores and comparing the calculated mean with an appropriate threshold.

23. The method according to claim 19, wherein the step of performing user recognition based on said comparison comprises calculating a trimmed mean of the normalised scores and comparing the calculated trimmed mean with an appropriate threshold.

24. The method according to claim 19, wherein the step of performing user recognition based on said comparison comprises comparing each normalised score with an appropriate threshold to obtain a respective result, and determining whether the user who provided the second biometric data was the enrolled user who provided the first biometric data based on a majority of the respective results.

25. The method according to claim 19, wherein the step of performing user recognition based on said comparison comprises calculating a median of the normalised scores and comparing the calculated median with an appropriate threshold.

26. A system for biometric user recognition, the system comprising:
an input, for, in an enrolment stage, receiving first biometric data relating to a biometric identifier of the user;
and being configured for:
generating a plurality of biometric prints for the biometric identifier, based on the received first biometric data; and
enrolling the user based on the plurality of biometric prints, and
further comprising:
an input for, in a verification stage, receiving second biometric data relating to the biometric identifier of the user;
and being configured for:
performing a comparison of the received second biometric data with the plurality of biometric prints; and
performing user recognition based on said comparison

27. The device comprising a system as claimed in claim 26.

28. The device as claimed in claim 27, wherein the device comprises a mobile telephone, an audio player, a video player, a mobile computing platform, a games device, a remote controller device, a toy, a machine, or a home automation controller or a domestic appliance.

29. The computer program product, comprising a computer-readable tangible medium, and instructions for performing a method according to claim 1.

30. A non-transitory computer readable storage medium having computer-executable instructions stored thereon that, when executed by processor circuitry, cause the processor circuitry to perform a method according to claim 1.

31. A device comprising the non-transitory computer readable storage medium as claimed in claim 30.

32. The device as claimed in claim 31, wherein the device comprises a mobile telephone, an audio player, a video player, a mobile computing platform, a games device, a remote controller device, a toy, a machine, or a home automation controller or a domestic appliance.
